(19) United States
(12) Patent Application Publication
(10) Pub. No.: US 2025/0191594 A1
(43) Pub. Date: Jun. 12, 2025

(54) SOUND PROCESSING APPARATUS, SOUND PROCESSING METHOD, AND NON-TRANSITORY COMPUTER READABLE MEDIUM

(71) Applicant: CANON KABUSHIKI KAISHA, Tokyo (JP)

(72) Inventor: TOMOKUNI HIROSAWA, Kanagawa (JP)

(21) Appl. No.: 18/966,879

(22) Filed: Dec. 3, 2024

(30) Foreign Application Priority Data
Dec. 11, 2023 (JP) 2023-208695

(51) Int. Cl. G10L 19/005; G10L 21/0208

(52) U.S. Cl. CPC G10L 19/005; G10L 21/0208; G10L 2021/02082

(57) ABSTRACT

A sound processing apparatus acquires a first sound signal which is collected at a first position, acquires a second sound signal which is collected at a second position, transmitted from the second position by wireless communication, and received at the first position, acquires a difference between propagation time of a sound signal from the second position to the first position in the wireless communication of the sound signal, and propagation time of a sound from the second position to the first position in air propagation of the sound, acquires an attenuation factor of a sound from the second position to the first position in air propagation of the sound, and removes a third sound signal, which was acquired by attenuating the second sound signal based on the attenuation factor and delaying the second sound signal based on the difference, from the first sound signal.

### BACKGROUND OF THE INVENTION

### Field of the Invention

The present invention relates to a sound processing apparatus, a sound processing method, and a non-transitory computer readable medium.

### Description of the Related Art

A technique that is proposed is: in a case where a sound, other than a desired sound, is inputted to a microphone (hereafter “mike”), this sound signal is regarded as a noise signal, and is removed (cancelled) so that only the desired sound signal is acquired. Japanese Patent Application Publication No. 2012-100235 discloses a technique where front and rear mikes are disposed in a camera, and a sound signal acquired by the rear mike is regarded as noise, and is removed from a sound signal acquired by the front mike.

In a case of using a first mike and a second mike, a sound inputted to the second mike may be inputted to the first mike with delay. In this case, even if the technique disclosed in Japanese Patent Application Publication No. 2012-100235 is used, the sound signal of this sound inputted to the second mike (sound inputted to the first mike with delay) cannot be removed from the sound signal acquired by the first mike. Therefore if the sound signal acquired by the second mike is acquired by wireless communication and is synthesized with the sound signal acquired by the first mike, the sound signal, in which the sound inputted to the second mike is echoed, is acquired.

### SUMMARY OF THE INVENTION

The present invention provides a technique to remove a sound signal of a sound, which is inputted to the second mike distant from the first mike (sound inputted to the first mike with delay), from a sound signal acquired by the first mike.

The present invention in its first aspect provides a sound processing apparatus including a processor, and a memory storing a program which, when executed by the processor, causes the sound processing apparatus to execute first sound acquisition processing to acquire a first sound signal which is collected at a first position, execute second sound acquisition processing to acquire a second sound signal which is collected at a second position, transmitted from the second position by wireless communication, and received at the first position, execute time difference acquisition processing to acquire a difference between propagation time of a sound signal from the second position to the first position in the wireless communication of the sound signal, and propagation time of a sound from the second position to the first position in air propagation of the sound, execute attenuation factor acquisition processing to acquire an attenuation factor of a sound from the second position to the first position in air propagation of the sound, and execute correction processing to remove a third sound signal, which was acquired by attenuating the second sound signal based on the attenuation factor and delaying the second sound signal based on the difference, from the first sound signal.

The present invention in its second aspect provides a sound processing method including acquiring a first sound signal which is collected at a first position, acquiring a second sound signal which is collected at a second position, transmitted from the second position by wireless communication, and received at the first position, acquiring a difference between propagation time of a sound signal from the second position to the first position in the wireless communication of the sound signal, and propagation time of a sound from the second position to the first position in air propagation of the sound, acquiring an attenuation factor of a sound from the second position to the first position in air propagation of the sound, and removing a third sound signal, which was acquired by attenuating the second sound signal based on the attenuation factor and delaying the second sound signal based on the difference, from the first sound signal.

The present invention in its third aspect provides a non-transitory computer readable medium that stores a program, wherein the program causes a computer to execute a sound processing method including acquiring a first sound signal which is collected at a first position, acquiring a second sound signal which is collected at a second position, transmitted from the second position by wireless communication, and received at the first position, acquiring a difference between propagation time of a sound signal from the second position to the first position in the wireless communication of the sound signal, and propagation time of a sound from the second position to the first position in air propagation of the sound, acquiring an attenuation factor of a sound from the second position to the first position in air propagation of the sound, and removing a third sound signal, which was acquired by attenuating the second sound signal based on the attenuation factor and delaying the second sound signal based on the difference, from the first sound signal.

Further features of the present invention will become apparent from the following description of exemplary embodiments with reference to the attached drawings.

### BRIEF DESCRIPTION OF THE DRAWINGS

FIG. 1 is a block diagram depicting a configuration of a sound processing system according to Embodiment 1;

FIG. 2 is a flow chart depicting basic setting processing of a slave wireless mike unit;

FIG. 3 is a flow chart depicting basic setting processing of a master wireless mike unit;

FIG. 4 is a schematic diagram of a scene using the slave wireless mike unit and the master wireless mike unit;

FIG. 5 is a flow chart depicting sound processing including echo correction according to Embodiment 1;

FIGS. 6A to 6D are graphs indicating waveforms of various sound signals;

FIG. 7 is a block diagram depicting a configuration of a photographing system according to Embodiment 2;

FIG. 8 is a flow chart depicting sound processing including echo correction according to Embodiment 2; and

FIGS. 9A to 9C are graphs indicating waveforms of various sound signals.

### DESCRIPTION OF THE EMBODIMENTS

### Embodiment 1

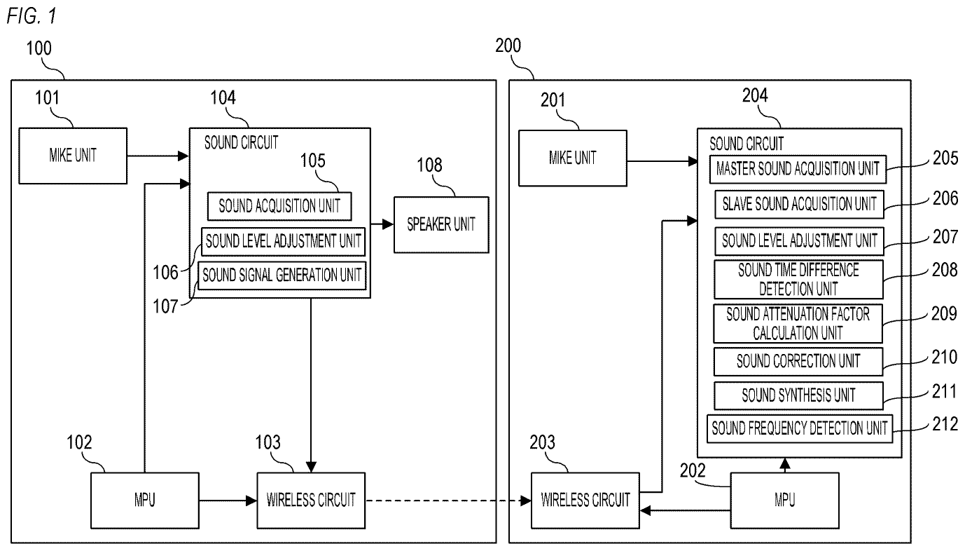

Embodiment 1 of the present invention will be described. FIG. 1 is a block diagram depicting a configuration of a sound processing system according to Embodiment 1. The sound processing system in FIG. 1 includes a slave wireless mike unit (hereafter “slave unit”) 100, and a master wireless mike unit (hereafter “master unit”) 200. The master unit 200 can be used with an imaging apparatus (e.g. digital camera), for example. The scene where the sound processing system is used is not especially limited, but in Embodiment 1, it is assumed that the sound processing system is used in a photographing scene, where the slave unit 100 is used at a position of an object, and the master unit 200 is used at a position distant from the object (e.g. at position of the photographer).

The slave unit 100 includes a slave mike unit 101, a slave micro-processing unit (MPU) 102, a slave wireless circuit 103, a slave sound circuit 104, and a speaker unit 108.

The slave mike unit 101 includes a circuit to convert inputted sound into an electric signal (sound signal), and is used to acquire sound of the object.

The slave MPU 102 controls the operation of the slave unit 100. The slave MPU 102 includes a ROM (not illustrated) in which programs to control operation of the slave unit 100 are stored, a RAM (not illustrated) in which variables are stored, and an EEPROM (electrically erasable programmable memory) (not illustrated) in which various parameters are stored. The slave MPU 102 controls the operation of the slave unit 100 by developing the programs, which are stored in the ROM, in the RAM, and executing the programs. For example, the slave MPU 102 sends control signals to the slave wireless circuit 103 and the slave sound circuit 104 based on a predetermined communication system, such as SPI communication or I2C communication, and controls the operation of the slave wireless circuit 103 and the operation of the slave sound circuit 104 thereby.

The slave wireless circuit 103 wirelessly transmits a sound signal acquired by the slave mike unit 101 to a master wireless circuit 203 of the master unit 200 via the slave sound circuit 104. The transmission (wireless communication) system is Bluetooth (registered trademark) or Zigbee (registered trademark), for example. The sound signal acquired by the slave mike unit 101 may be interpreted as a sound signal collected at a position of the object (position of the slave unit 100). The transmission from the slave wireless circuit 103 to the master wireless circuit 203 may be interpreted as transmission from the position of the object to a position of the photographer (position of the master unit 200).

The slave sound circuit 104 includes a sound acquisition unit 105, a sound level adjustment unit 106, and a sound signal generation unit 107. The sound acquisition unit 105 acquires a sound signal, obtained by the slave mike unit 101, from the slave mike unit 101. The sound level adjustment unit 106 adjusts the sound level of the sound signal obtained by the sound acquisition unit 105 (sound signal obtained by the slave mike unit 101). For example, the sound level adjustment unit 106 adjusts the sound level with a gain which is set by a register. The sound signal generation unit 107 generates a sound signal which is outputted to the speaker unit 108.

The speaker unit 108 outputs the sound in accordance with the sound signal outputted from the slave sound circuit 104 (sound signal generation unit 107).

The master unit 200 includes a master mike unit 201, a master MPU 202, the master wireless circuit 203, and a master sound circuit 204.

The master mike unit 201 includes a circuit to convert inputted sound into an electric signal (sound signal), and is used to acquire an environmental sound.

The master MPU 202 controls the operation of the master unit 200. The master MPU 202 includes a ROM (not illustrated) in which programs to control operation of the master unit 200 are stored, a RAM (not illustrated) in which variables are stored, and an EEPROM (electrically erasable programmable memory) in which various parameters are stored. The master MPU 202 controls operation of the master unit 200 by developing the programs which are stored in ROM, in the RAM, and executing the programs. For example, the master MPU 202 sends control signals to the master wireless circuit 203 and the master sound circuit 204 based on a predetermined communication system, such as SPI communication or I2C communication, and controls the operation of the master wireless circuit 203 and the operation of the master sound circuit 204 thereby.

The master wireless circuit 203 receives sound signals transmitted from the slave wireless circuit 103 of the slave unit 100. The communication system of the slave wireless circuit 103 and the communication system of the master wireless circuit 203 are the same.

The master sound circuit 204 includes a master sound acquisition unit 205, a slave sound acquisition unit 206, a sound level adjustment unit 207, a sound time difference detection unit 208, a sound attenuation factor calculation unit 209, a sound correction unit 210, a sound synthesis unit 211, and a sound frequency detection unit 212.

The master sound acquisition unit 205 acquires a sound signal, obtained by the master mike unit 201, from the master mike unit 201. The sound signal obtained by the master mike unit 201 may be interpreted as a sound signal collected at a position of the photographer (position of the master unit 200).

The slave sound acquisition unit 206 acquires the sound signal, which was received by the master wireless circuit 203, from the master wireless circuit 203. Hereafter the sound signal acquired by the slave sound acquisition unit 206 (sound signal which was acquired by the slave mike unit 101, transmitted from the slave wireless circuit 103 by wireless communication, and received by the master wireless circuit 203) is called “a slave sound signal”.

The sound level adjustment unit 207 adjusts the sound level of the sound signal acquired by the master sound acquisition unit 205 (sound signal acquired by the master mike unit 201). For example, the sound level adjustment unit 207 adjusts the sound level with the gain which is set by the register. Hereafter the sound signal acquired by the master sound acquisition unit 205 and adjusted by the sound level adjustment unit 207 (sound signal acquired by the master mike unit 201) are called “a master sound signal”.

The sound time difference detection unit 208 acquires the time difference between the master sound signal and the slave sound signal. The sound time difference detection unit 208 includes a circuit to detect the time difference between the master sound signal and the slave sound signal. Hereafter this time difference is called “a sound time difference”.

The sound time difference is a difference between a propagation time of a sound signal from a position of the object (position of the slave unit 100) to a position of the photographer (position of the master unit 200) in the wireless communication, and a propagation of the sound from the position of the object to the position of the photographer in the air propagation of the sound. Hereafter the propagation time in the wireless communication is called “wireless propagation time”, and the propagation time in the air propagation is called “air propagation time”. The wireless propagation time may be interpreted as the time from transmission of the slave sound signal from the slave unit 100 (slave wireless circuit 103) to the slave sound signal reaching the master unit 200 (master wireless circuit 203). The air propagation time may be interpreted as the time from emission of the sound from the object or the slave unit 100 (speaker unit 108) to the sound reaching the master unit 200 (master mike unit 201).

The sound attenuation factor calculation unit 209 acquires the attenuation factor of the sound in the air propagation from the position of the object to the position of the photographer. The sound attenuation factor calculation unit 209 includes a circuit to calculate (detect) the ratio between the sound level of the master sound signal and the sound level of the slave sound signal as the attenuation factor. Hereafter this attenuation factor is called “sound attenuation factor”.

On the basis of the sound time difference acquired by the sound time difference detection unit 208 and the sound attenuation factor acquired by the sound attenuation factor calculation unit 209, the sound correction unit 210 corrects the master sound signal. In Embodiment 1, the sound correction unit 210 causes the slave sound signal to delay on the basis of the sound time difference, and to attenuate on the basis of the sound attenuation factor. Then the sound correction unit 210 removes (cancels) the delayed and attenuated slave sound signal from the master sound signal.

The sound synthesis unit 211 synthesizes the master sound signal and the slave sound signal. In the case where the sound correction unit 210 corrected the master sound signal, the sound synthesis unit 211 synthesizes the corrected master sound signal and the slave sound signal.

The sound frequency detection unit 212 detects the frequency of the master sound signal or detects the frequency of the slave sound signal. The sound frequency detection unit 212 may set (specify) the frequency band in advance by the register, and detect whether the frequency of the sound signal is included in the set frequency band (predetermined frequency band).

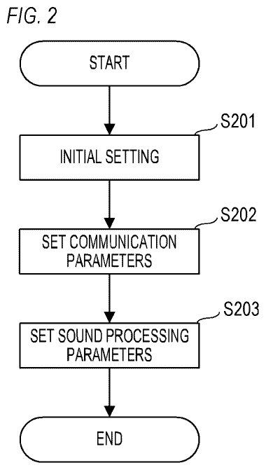

FIG. 2 is a flow chart depicting basic setting processing of the slave unit 100. For example, when the power of the slave unit 100 is turned ON, the basic setting processing in FIG. 2 is started.

In step S201, the slave MPU 102 initializes the variables and programs stored in the RAM, and executes the preparation operation, such as supplying power to the slave wireless circuit 103 and the slave sound circuit 104.

In step S202, the slave MPU 102 sets communication parameters of the slave wireless circuit 103. The communication parameters of the slave wireless circuit 103 includes: a MAC address, a service set identifier (SSID), a data channel, and a transmission rate, for example.

In step S203, the slave MPU 102 sets sound processing parameters of the slave sound circuit 104. The sound processing parameters of the slave sound circuit 104 include: a gain to adjust the sound level, frequency characteristics of an equalizer (sound quality adjustment), a filter to prevent wind noise, and generation/no generation of sound signals to be outputted to the speaker unit 108, for example. The sound processing parameters of the slave sound circuit 104 can be set by changing the setting in the register of the slave sound circuit 104.

By executing the processing from step S201 to S203, the setting of the slave unit 100 is completed, and the sound signal acquired by the slave mike unit 101 can be transmitted to the master unit 200.

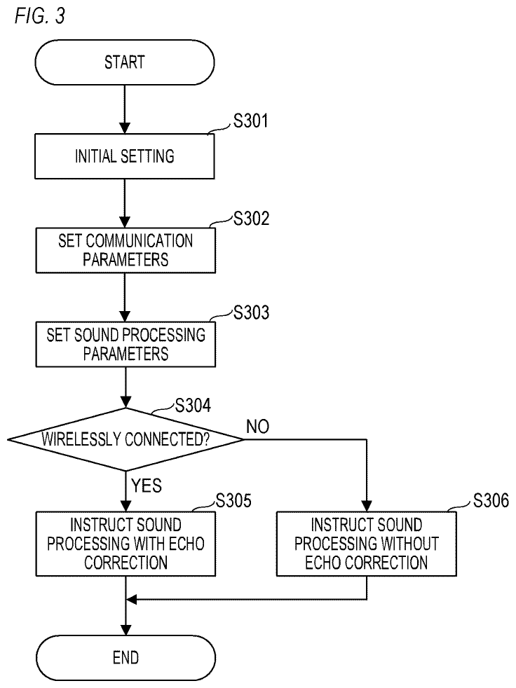

FIG. 3 is a flow chart depicting basic setting processing of the master unit 200. For example, when the power of the master unit 200 is turned ON, the basic setting processing in FIG. 3 is started.

In step S301, the master MPU 202 initializes the variables and programs stored in the RAM, and executes the preparation operation, such as supplying power to the master wireless circuit 203 and the master sound circuit 204.

In step S302, the master MPU 202 sets communication parameters of the master wireless circuit 203. The communication parameters of the master wireless circuit 203 include: a MAC address, an SSID, a data channel, and a transmission rate, for example, just like the communication parameters of the slave wireless circuit 103.

In step S303, the master MPU 202 sets sound processing parameters of the master sound circuit 204. The sound processing parameters of the master sound circuit 204 include: a gain to adjust the sound level, frequency characteristics for an equalizer (sound quality adjustment), and a filter to prevent wind noise, for example. The sound processing parameters of the master sound circuit 204 can be set by changing the setting in the register of the master sound circuit 204.

In step S304, the master MPU 202 determines whether the master wireless circuit 203 is connected to the slave wireless circuit 103. The master MPU 202 advances processing to step S305 if it is determined that the master wireless circuit 203 is connected to the slave wireless circuit 103, or advances processing to step S306 if it is determined that the master wireless circuit 203 is not connected to the slave wireless circuit 103. For example, if the power supply of the slave unit 100 is OFF, the master wireless circuit 203 is not connected to the slave wireless circuit 103, and processing advances to step S306. It is possible to use only the master unit 200 without wirelessly connecting the slave unit 100 and the master unit 200, and in this case, echo correction described below is not required.

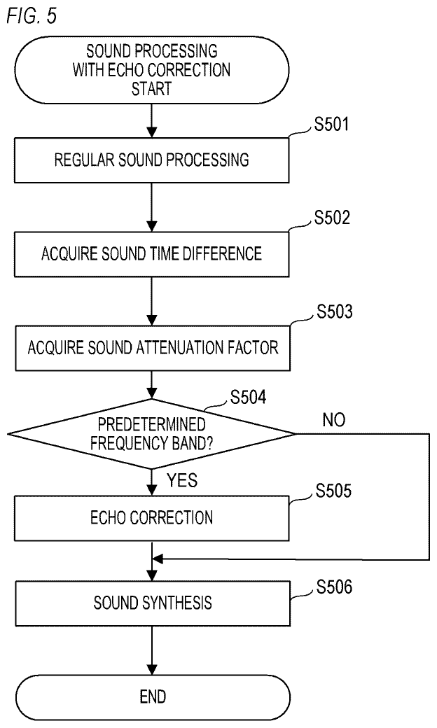

In step S305, the master MPU 202 instructs the master sound circuit 204 to execute sound processing including echo correction. The sound processing including echo correction will be described in detail later with reference to FIG. 5.

In step S306, the master MPU 202 instructs the master sound circuit 204 to execute sound processing without including echo correction. In the sound processing without including echo correction, adjustment of the sound level, equalizer processing (sound quality adjustment), and filter processing to prevent wind noise, for example, are performed on the sound signal inputted from the master mike unit 201. The sound processing without including echo correction is continuously performed until power of the master unit 200 is turned OFF, for example.

By performing the processing from step S301 to step S306, the setting of the master unit 200 is completed, and acquisition of the slave sound signal and acquisition of the master sound signal become possible. If the master unit 200 and the slave unit 100 are connected after the processing in FIG. 3 is completed, the start of transmission of the sound signal is instructed to the slave unit 100 by the master wireless circuit 203. The master wireless circuit 203 sends a control signal to instruct the start of transmission of the sound signal to the slave unit 100. The slave wireless circuit 103 receives the control signal to instruct the start of transmission of the sound signal from the master wireless circuit 203, and sends the control signal to the slave MPU 102. Responding to the instruction to start transmission of the slave sound signal, the slave MPU 102 controls the sound circuit 104, and starts acquiring the slave sound signal. Then the slave MPU 102 controls the wireless circuit 103 and transmits the slave sound signal to the master unit 200. Hereafter if the slave unit 100 is connected to the master unit 200 in the power ON state, the slave MPU 102 continues transmitting the slave sound signal to the master unit 200.

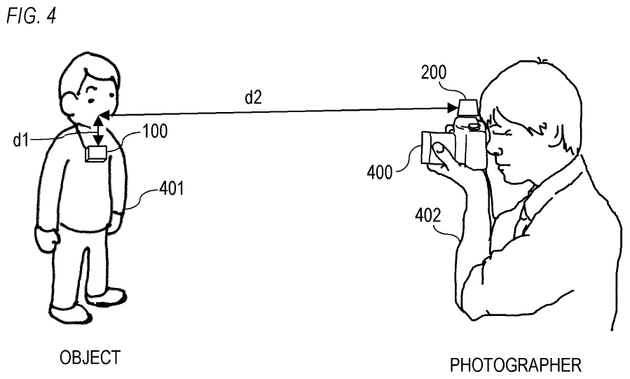

FIG. 4 is a schematic diagram depicting a scene of using the slave unit 100 and the master unit 200. In FIG. 4, in order to acquire sound (voice) of an object (e.g. interviewer) 401, the slave unit 100 is disposed near the mouth of the object. The master unit 200 is connected to a camera 400 held by a photographer 402 who is distant from the object 401. The master unit 200 receives a slave sound signal from the slave unit 100, synthesizes the slave sound signal with master sound signal, and outputs the synthesized sound signal to the camera 400. The camera 400 records the sound signals from the master unit 200, along with the moving image captured by the camera 400. The storage medium to store the synthesized sound signal, generated by synthesizing the master sound signal and the slave sound signal, is not limited to the camera.

The sound of the object 401 inputted to the slave unit 100 may be inputted to the master unit 200 as well in an attenuated and delayed state by air propagation. In this case, the timing of the sound of the object 401 indicated by the slave sound signal, and the timing of the sound of the object 401 indicated by the master sound signal, deviate. Therefore when the slave sound signal and the master sound signal are synthesized, the sound of the object 401, included in the synthesized sound signal, is echoed.

Hence in Embodiment 1, echo correction is performed. The echo correction is a processing to remove the sound signal of the sound inputted to the slave unit 100 (sound inputted to the master unit 200 in an attenuated and delayed state) from the master sound signal. By performing this echo correction, the state where the sound of the object 401 is echoed can be reduced from the synthesized sound signals.

FIG. 5 is a flow chart depicting the sound processing including the echo correction according to Embodiment 1. For example, the master sound circuit 204 starts the sound processing in FIG. 5 when the instruction in step S305 in FIG. 3 is received from the master MPU 202. The sound processing in FIG. 5 is repeatedly performed until the wireless connection between the slave unit 100 and the master unit 200 is cancelled, or until the power of the master unit 200 is turned OFF, for example.

In step S501, the master sound circuit 204 performs regular sound processing. In the regular sound processing, just like the sound processing without including the echo correction, adjustment of the sound level, equalizer processing (sound quality adjustment) and filter processing to prevent wind noise, for example, are performed on the sound signal inputted from the master mike unit 201. The sound level adjustment unit 207 is used for adjusting the sound level.

Further, in step S501, the master MPU 202 sends a control signal to the slave unit 100 via the master wireless circuit 203, to instruct output of a predetermined sound (sound having a predetermined frequency), for detecting the sound time difference and the sound attenuation factor. This predetermined sound is hereafter called “speaker sound”. The slave wireless circuit 103 receives this control signal and sends it to the slave MPU 102. The slave MPU 102 controls the sound circuit 104 in accordance with the control signal to instruct output of the speaker sound, and causes the speaker unit 108 to output the speaker sound.

In step S502, the master sound circuit 204 acquires the sound time difference using the sound time difference detection unit 208. In step S503, the master sound circuit 204 acquires the sound attenuation factor using the sound attenuation factor calculation unit 209.

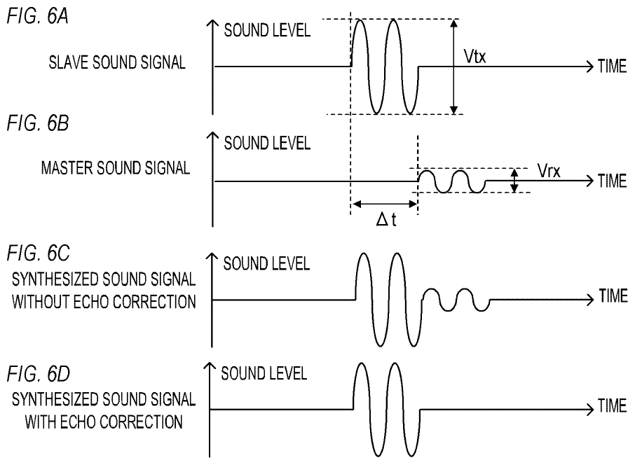

The method for acquiring the sound time difference and the sound attenuation factor will be described in detail with reference to FIGS. 6A and 6B. FIGS. 6A and 6B (and later mentioned FIGS. 6C and 6D) are graphs indicating waveforms of various sound signals. In FIGS. 6A to 6D, the abscissa indicates time, and the ordinate indicates the sound level.

In Embodiment 1, it is assumed that the sound time difference and the sound attenuation factor are acquired on the basis of the master sound signal and the slave sound signal which are acquired by the master unit 200 and the slave unit 100 respectively when a predetermined sound (e.g. sound of predetermined frequency) is outputted from the speaker unit 108. The positions of the slave unit 100 and the master unit 200, in the case of acquiring the sound time difference and sound attenuation factor, are assumed to be the same as the positions of the slave unit 100 and the master unit 200 in the case of acquiring sound from the object.

FIG. 6A is a waveform of a slave sound signal acquired by the slave unit 100 when the speaker sound is outputted. FIG. 6B is a waveform of a master sound signal acquired by the master unit 200 when the speaker sound is outputted.

The method for acquiring the sound time difference will be described first.

The slave sound signal in FIG. 6A is a sound signal that is delayed from the timing of the emission of the speaker sound by the amount of the wireless propagation time mentioned above. In the slave sound signal in FIG. 6A, the waveform of the speaker sound appears after a delay from the timing of the emission of the speaker sound by the amount of the wireless propagation time. The wireless propagation time is uniquely determined by the slave wireless circuit 103 and the master wireless circuit 203, hence the information to indicate the wireless propagation time can be provided in advance. In Embodiment 1, it is assumed that the information to indicate the wireless propagation time has been stored in the EEPROM of the master MPU 202 in advance. The wireless propagation time may be interpreted as a delay time from the timing of the emission of the sound from the speaker unit 108 or the object to the timing when the waveform of this sound appears in the slave sound signal.

The master sound signal in FIG. 6B is a sound signal that is delayed from the timing of the emission of the speaker sound by the amount of the air propagation time mentioned above. In the master sound signal in FIG. 6B, the waveform of the speaker sound appears after a delay from the timing of the emission of the speaker sound by the amount of the air propagation time. Since the wireless propagation time and the air propagation time are different, in the master sound signal in FIG. 6B, the waveform of the speaker sound appears at a timing different from the timing when the waveform of the speaker sound appears in the slave sound signal in FIG. 6A. The air propagation time may be interpreted as a delay time from the timing of the emission of the sound from the speaker unit 108 or the object to the timing when the waveform of this sound appears in the master sound signal.

The sound frequency detection unit 212 detects the frequency of the speaker sound from the slave sound signal and the master sound signal respectively. Thereby the timing of the speaker sound in the slave sound signal and the timing of the speaker sound in the master sound signal are detected. The sound time difference detection unit 208 calculates the time Δt from the timing of the speaker sound in the slave sound signal to the timing of the speaker sound in the master sound signal, as the sound time difference (difference between the wireless propagation time and the air propagation time).

The method for acquiring the sound attenuation factor will be described next.

As mentioned above, the sound frequency detection unit 212 detects the frequency of the speaker sound from the slave sound signal and the master sound signal respectively. Thereby a period of the speaker sound in the slave sound signal and a period of the speaker sound in the master sound signal are detected. Then the sound attenuation factor calculation unit 209 calculates a ratio Vrx/Vtx, that is, a ratio of the sound level of the speaker sound in the master sound signal (amplitude Vrx) with respect to the sound level of the speaker sound in the slave sound signal (amplitude Vtx), as the sound attenuation factor. The amplitude Vtx is a value determined by dividing the slave sound signal by gain Gaintx, which is set in the sound level adjustment unit 106, and the amplitude Vrx is a value determined by dividing the master sound signal by gain Gainrx, which is set in the sound level adjustment unit 207. By performing the normalization using the gain Gaintx and Gainrx, the ratio Vrx/Vtx, which accurately indicates the attenuation factor (attenuation amount) of the sound in the air propagation of this sound from the position of the object to the position of the photographer, can be acquired.

The acquisition methods of the sound time difference and the sound attenuation factor are not limited to the above methods, and the sound time difference and the sound attenuation factor may be acquired on the basis of the master sound signal and the slave sound signal acquired when the object emitted his/her voice. Further, the sound processing in FIG. 5 is performed repeatedly here, but the sound time difference and sound attenuation factor may not always be acquired repeatedly. For example, the processing to acquire the sound time difference and the sound attenuation factor may be performed only once, and the acquired sound time difference and the sound attenuation factor may be used repeatedly in step S505, which will be described later. The master unit 200 may acquire the sound time difference and the sound attenuation factor externally.

The description in FIG. 5 continues. In step S504, the master sound circuit 204 determines whether the slave sound signal is a sound signal in a predetermined frequency band, using the sound frequency detection unit 212. The master sound circuit 204 advances processing to step S505 if it is determined that the slave sound signal is a sound signal in the predetermined frequency band, or advances processing to step S506 if it is determined that the slave sound signal is not a sound signal in the predetermined frequency band. In Embodiment 1, the slave unit 100 is used to acquire the sound of the object, hence the frequency band of a human voice, that is, a frequency band of at least 120 Hz and not more than 300 Hz, is used as the predetermined frequency band.

In step S505, the master sound circuit 204 performs echo correction on the master sound signal using the sound correction unit 210. By the determination in step S504, only the master sound signals in the predetermined frequency band become the target of echo correction. Step S504 may be omitted.

Echo correction will be described in detail. The sound signal in FIG. 6C is a synthesized sound signal of the slave sound signal in FIG. 6A and the master sound signal in FIG. 6B. The timing of the speaker sound in the slave sound signal in FIG. 6A and in the master sound signal in FIG. 6B are different, hence in the synthesized sound signal in FIG. 6C, the waveform of the speaker sound appears in 2 locations. In the case of the sound of the object as well, the waveform of the same sound of the object appears in 2 locations in the synthesized sound signal, just like the case of the speaker sound. To solve this problem, the echo correction is performed. Echo correction is performed using the sound time difference Δt acquired in step S502, and the sound attenuation factor Vrx/Vtx acquired in step S503.

Using the following Expression 1, the sound correction unit 210 calculates a correction value C (t) from the slave sound signal ftx (t), the sound time difference Δt, and the sound attenuation factor Vrx/Vtx. A variable t is a timing (temporal position). The slave sound signal ftx (t) may be interpreted as a sound level of the slave sound signal. The slave sound signal ftx (t-Δt) may be interpreted as a sound level of the signal generated by delaying the slave sound signal by the sound time difference Δt.

$$\begin{matrix}[ Math . 1 ] & \\ C ( t ) = ftx ( t - Δ t ) \times \frac{Vrx}{Vtx} & ( Expression 1 )\end{matrix}$$

Then using the following Expression 2 (correction formula), the sound correction unit 210 calculates a post-echo correction master sound signal frx2 (t) from the correction value C (t), gains Gaintx, Gainrx and a master sound signal frx (t). The pre-echo correction master sound signal frx (t) may be interpreted as the sound level of the pre-echo correction master sound signal. The post-echo correction master sound signal frx2 (t) may be interpreted as the sound level of the post-echo correction master sound signal.

$$\begin{matrix}[ Math . 2 ] & \\ \begin{matrix}ftx 2 ( t ) = frx ( t ) \times \frac{Gaintx}{Gainrx} - C ( t ) \\ = frx ( t ) \times \frac{Gaintx}{Gainrx} - ftx ( t - Δ t ) \times \frac{Vrx}{Vtx}\end{matrix} & ( Expression 2 )\end{matrix}$$

For example, the echo correction of Expression 2 can be implemented by subtracting a correction value, based on the slave sound signal at time Δt ago, from the master sound signal, using a dedicated hardware block constructed by a sequential circuit (e.g. flip-flop). In a case where the master sound circuit 204 does not include the dedicated hardware block, the correction value based on the slave sound signal is stored in the RAM of the master MPU 202, and the correction value at time Δt minutes ago is read from the RAM, and this value is subtracted from the master sound signal. Thereby the echo correction in Expression 2 can be implemented.

The description in FIG. 5 continues. In step S506, the master sound circuit 204 synthesizes the master sound signal and the slave sound signal using the sound synthesis unit 211. In the case where the echo correction in step S505 is performed, the post-echo correction master sound signal frx2 (t) and the slave sound signal ftx (t) are synthesized using the following Expression 3, and a synthesized sound signal f (t) is acquired. The synthesized sound signal f (t) may be interpreted as a sound level of the synthesized sound signal.

$$\begin{matrix}[ Math . 3 ] & \\ \begin{matrix}frx ( t ) = ftx 2 ( t ) + ftx ( t ) \\ = frx ( t ) \times \frac{Gaintx}{Gainrx} - ftx ( t - Δ t ) \times \frac{Vrx}{Vtx} + ftx ( t )\end{matrix} & ( Expression 3 )\end{matrix}$$

The sound signal in FIG. 6D is a synthesized sound signal of the slave sound signal in FIG. 6A and the sound signal generated by performing the echo correction on the master sound signal in FIG. 6B. In the synthesized sound signal in FIG. 6D, the waveform of the speaker sound appears at one place, that is, the problem described in FIG. 6C has been solved. In the case of the sound of the object as well, the problem described in FIG. 6C can be solved, just like the case of the speaker sound.

As described above, according to Embodiment 1, the sound time difference and the sound attenuation ratio are acquired, and sound signal, generated by delaying the slave sound signals based on the sound time difference and attenuating the slave sound signals based on the sound attenuation ratio, is removed (cancelled) from the master sound signal. Thereby the sound signal of a sound inputted to the slave unit distant from the master unit (sound inputted to the master unit with delay) can be removed from the sound signal acquired by the master unit. Further, acquisition of synthesized sound signal, in which the sound of the object is echoed, can be suppressed.

### Embodiment 2

Embodiment 2 of the present invention will be described. In the following, description on aspects the same as Embodiment 1 (e.g. configuration and processing the same as Embodiment 1) will be omitted, and only aspects different from Embodiment 1 will be described.

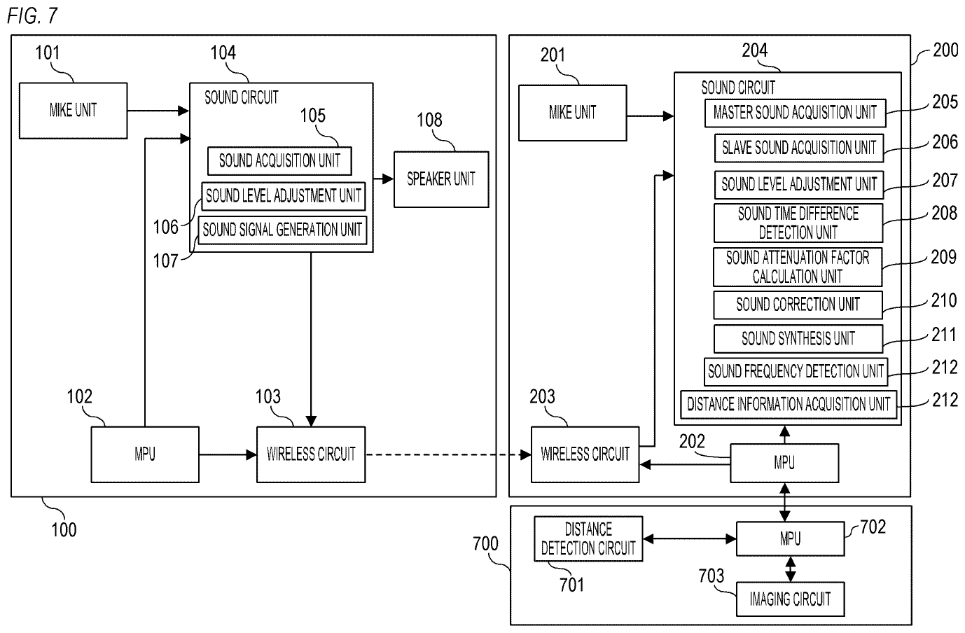

FIG. 7 is a block diagram depicting a configuration of a photographing system according to Embodiment 2. The photographing system in FIG. 7 includes a slave unit 100, a master unit 200, and a camera 700. The slave unit 100 has the same configuration as in Embodiment 1. The master unit 200 has approximately the same configuration as in Embodiment 1. A master sound circuit 204 of the master unit 200 has a configuration different from Embodiment 1. Just like Embodiment 1, the master sound circuit 204 includes the master sound acquisition unit 205, the slave sound acquisition unit 206, the sound level adjustment unit 207, the sound time difference detection unit 208, the sound attenuation factor calculation unit 209, the sound correction unit 210, the sound synthesis unit 211, and the sound frequency detection unit 212. The master sound circuit 204 also includes a distance information acquisition unit 213. The camera 700 includes a distance detection circuit 701, a camera MPU 702, and an imaging circuit 703. The master unit 200 and the camera 700 may be integrated as one unit.

The distance detection circuit 701 is a circuit to calculate (detect) a distance from an object to the camera 700 using a known method, such as time-of-flight (TOF) method, and includes a sensor to calculate this distance.

The imaging circuit 703 includes an image pickup element (an image sensor). The imaging circuit 703 can calculate (detect) a distance from an object to the camera 700 by a known method. For example, the imaging circuit 703 calculates the distance from the object to the camera 700 based on an image acquired by the image pickup element. In a case of turning the camera 700 to an object wearing the slave unit 100, the distance to the object wearing the slave unit 100 can be acquired by the distance detection circuit 701 or the imaging circuit 703.

The camera MPU 702 controls the operation of the camera 700. The camera MPU 702 includes a ROM (not illustrated) in which programs to control operation of the camera 700 are stored, a RAM (not illustrated) in which variables are store, and an EEPROM (electrically erasable programmable memory) (not illustrated) in which various parameters are stored. The camera MPU 702 controls the operation of the camera 700 by developing the programs, which are stored in the ROM, in the RAM, and executing the programs. For example, the camera MPU 702 sends control signals to the distance detection circuit 701 and the imaging circuit 703 based on a predetermined communication system, such as SPI communication or I2C communication, and controls the operation of the distance detection circuit 701 and the operation of the imaging circuit 703 thereby.

The camera MPU 702 can communicate with the master MPU 202 via an external I/F (not illustrated) disposed in the camera 700 and an external I/F (not illustrated) disposed in the master unit 200. For example, using a predetermined communication system (e.g. SPI communication, I2C communication), the camera MPU 702 sends information indicating a distance (distance from the object to the camera 700), calculated by the distance detection circuit 701 or the imaging circuit 703, to the master MPU 202.

The distance information acquisition unit 213 of the master unit 200 acquires photographing distance information, which indicates the distance from the object to the camera 700, from the camera MPU 702 via the master MPU 202. In Embodiment 2, the distance from the object to the camera 700 is assumed to be the same as the distance from the object to the master unit 200. Therefore, the photographing distance information may be interpreted as the information indicating the distance from the object to the master unit 200. The acquisition method of the photographing distance information is not especially limited, and the master unit 200 may include a sensor to acquire the photographing distance information, for example.

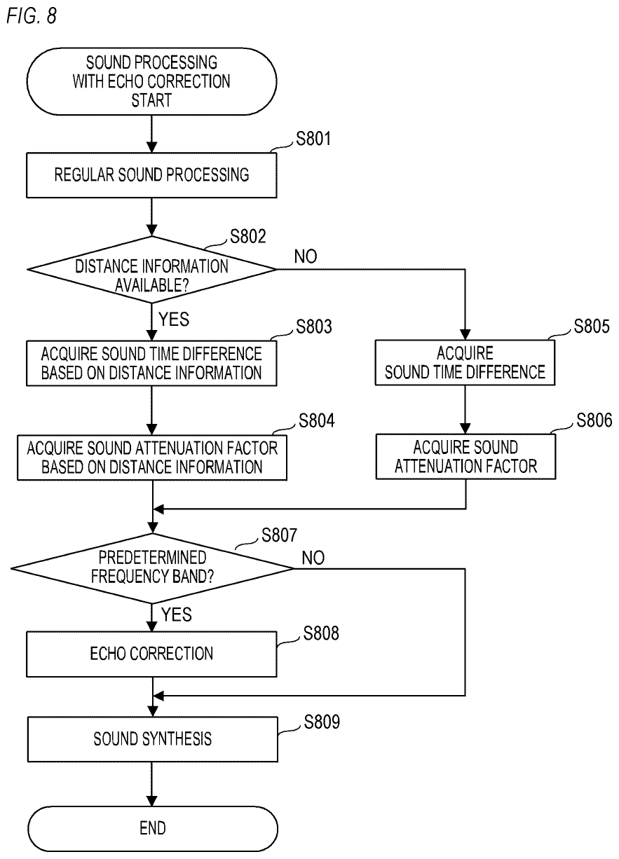

FIG. 8 is a flow chart depicting the sound processing including the echo correction according to Embodiment 2. For example, the master sound circuit 204 starts the sound processing in FIG. 8 when the instruction in step S305 in FIG. 3 is received from the master MPU 202. The sound processing in FIG. 8 is performed repeatedly until the wireless connection between the slave unit 100 and the master unit 200 is cancelled, or until the power of the master unit 200 is turned OFF. The processing in FIG. 8 will be described on the basis of the assumption that the user is turning the camera 700 toward an object wearing the slave unit 100.

Step S801 is the same as step S501 in FIG. 5. In step S802, the master sound circuit 204 determines whether there is photographing distance information. The master sound circuit 204 performs processing in steps S803 and 804 if it is determined that there is the photographing distance information, or performs processing in steps S805 and S806 if it is determined that there is no photographing distance information. Steps S805 and S806 are the same as steps S502 and S503 in FIG. 5.

In step S803, the master sound circuit 204 acquires the air propagation time based on the photographing distance information, and acquires the sound time difference. To acquire the sound time difference, the sound time difference detection unit 208 is used, just like step S805.

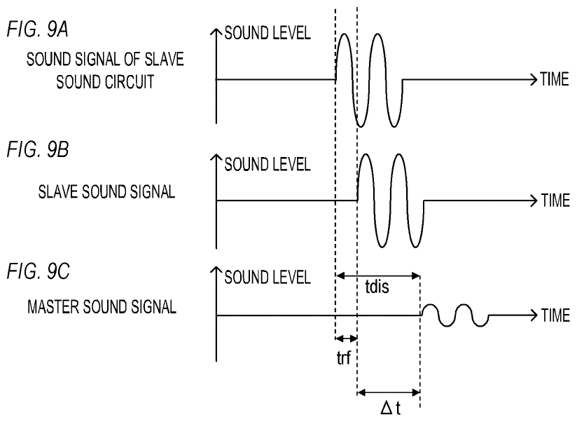

The method for acquiring the sound time difference based on the photographing distance information will be described in detail with reference to FIGS. 9A to 9C. FIGS. 9A to 9C are graphs indicating the waveforms of various sound signals. In FIGS. 9A to 9C, the abscissa indicates time, and the ordinate indicates the sound level. The sound signal in FIG. 9A is a sound signal that was acquired by the slave mike unit 101, and inputted to the slave sound circuit 104. The sound signal in FIG. 9B is a slave sound signal, and the sound signal in FIG. 9C is a master sound signal.

The time trf from the timing of the speaker sound in the sound signal in FIG. 9A to the timing of the speaker sound in the sound signal in FIG. 9B corresponds to the wireless propagation time. As described in Embodiment 1, the wireless propagation time is propagation time of the sound signal in the wireless communication, from the position of the object (position of the slave unit 100) to the position of the photographer (position of the master unit 200). The wireless propagation time is uniquely determined by the slave wireless circuit 103 and the master wireless circuit 203, hence the information to indicate the wireless propagation time can be provided in advance. In Embodiment 2, it is assumed that the information to indicate the wireless propagation time has been stored in the EEPROM of the master MPU 202 in advance.

The time tdis, from the timing of the speaker sound in the sound signal in FIG. 9A to the timing of the speaker sound in the sound signal in FIG. 9C, corresponds to the air propagation time. The air propagation time is propagation time of the sound in the air propagation, from the position of the object (position of the slave unit 100) to the position of the photographer (position of the master unit 200). The sound time difference detection unit 208 calculates the time tdis by dividing the distance indicated by the photographing distance information by sound speed. For example, if the distance from the master unit 200 to the object is 34 m and the sound speed is 340 m/sec, then time tdis is calculated as 0.1 sec.

The sound time difference detection unit 208 calculates the sound time difference Δt by subtracting the time trf from the time tdis using the following Expression 4. For example, if the distance from the master unit 200 to the object is 34 m, the sound speed is 340 m/sec, and the wireless propagation time is 0.01 sec, then the sound time difference Δt is calculated as 0.09 sec.

$$\begin{matrix}[ Math . 4 ] & \\ Δ t = tdis - trf & ( Expression 4 )\end{matrix}$$

The description in FIG. 8 continues. In step S804, the master sound circuit 204 acquires the sound attenuation factor based on the photographing distance information. To acquire the sound attenuation factor, the sound attenuation factor calculation unit 209 is used, just like step S806.

The method for acquiring the sound attenuation factor based on the photography distance information will be described in detail with reference to FIG. 4. In FIG. 4, the distance d1 from the object to the slave unit 100, and the distance d2 from the object to the master unit 200 are indicated. In Embodiment 2, it is assumed that the information indicating the distance d1 has been stored in advance in the EEPROM of the master MPU 202. The distance d2 is the distance indicated in the photographing distance information.

Since sound spreads spherically, the sound attenuation factor calculation unit 209 calculates the sound attenuation factor Vatt in decibel units, based on the distances d1 and d2 using the following Expression 5. For example, if the distance d1 is 0.1 m and the distance d2 is 10 m, then the sound attenuation factor Vatt is calculated as 40 dB.

$$\begin{matrix}[ Math . 5 ] & \\ Vatt = 10 \times log ( \frac{d {2}^{2}}{d {1}^{2}} ) & ( Expression 5 )\end{matrix}$$

The sound attenuation factor calculation unit 209 converts the sound attenuation factor Vatt into the sound attenuation factor Vrx/Vtx, using the following Expression 6.

$$\begin{matrix}[ Math . 6 ] & \\ \frac{Vrx}{Vtx} = {10}^{\frac{Vatt}{10}} & ( Expression 6 )\end{matrix}$$

Steps S807 to S809 are the same as steps S504 to S506 in FIG. 5.

As described above, according to Embodiment 2, the photographing distance information is acquired, and the sound time difference and the sound attenuation factor are acquired on the basis of this photographing distance information. Then just like Embodiment 1, the sound signal generated by delaying the slave sound signal based on the device time difference and attenuating the slave sound signal based on the sound attenuation factor are removed (cancelled) from the master sound signal. Thereby an effect similar to Embodiment 1 is implemented. Further, by using the photographing distance information, the sound time difference and the sound attenuation factor can be acquired without using the speaker sound, and a state where the object or the photographer is surprised or feels discomfort by the speaker sound can be prevented.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present invention are also included in the present invention. The present invention also includes other configurations obtained by suitably combining various features of the embodiment.

According to the present invention, a sound signal of a sound, which is inputted to the second mike distant from the first mike (sound inputted to the first mike with delay) can be removed from a sound signal acquired by the first mike.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-208695, filed on Dec. 11, 2023, which is hereby incorporated by reference herein in its entirety.

What is claimed is:

1. A sound processing apparatus comprising:
a processor; and
a memory storing a program which, when executed by the processor, causes the sound processing apparatus to
execute first sound acquisition processing to acquire a first sound signal which is collected at a first position;
execute second sound acquisition processing to acquire a second sound signal which is collected at a second position, transmitted from the second position by wireless communication, and received at the first position;
execute time difference acquisition processing to acquire a difference between propagation time of a sound signal from the second position to the first position in the wireless communication of the sound signal, and propagation time of a sound from the second position to the first position in air propagation of the sound;
execute attenuation factor acquisition processing to acquire an attenuation factor of a sound from the second position to the first position in air propagation of the sound; and
execute correction processing to remove a third sound signal, which was acquired by attenuating the second sound signal based on the attenuation factor and delaying the second sound signal based on the difference, from the first sound signal.

2. The sound processing apparatus according to claim 1, wherein
the program, when executed by the processor, further causes the sound processing apparatus to execute synthesis processing to synthesize a fourth sound signal, generated by removing the third sound signal from the first sound signal, and the second sound signal.

3. The sound processing apparatus according to claim 1, wherein
based on the first sound signal and the second sound signal acquired by emitting a predetermined sound at the second position, the attenuation factor is acquired in the attenuation factor acquisition processing, and the difference is acquired in the time difference acquisition processing.

4. The sound processing apparatus according to claim 3, wherein
in the time difference acquisition processing, time from timing of the predetermined sound in the second sound signal to timing of the predetermined sound in the first sound signal is acquired as the difference between the propagation time in the wireless communication and the propagation time in the air propagation.

5. The sound processing apparatus according to claim 3, wherein
in the attenuation factor acquisition processing, a ratio of a level of the predetermined sound in the first sound signal with respect to a level of the predetermined sound in the second sound signal is acquired as the attenuation factor.

6. The sound processing apparatus according to claim 1, wherein
information on the propagation time in the wireless communication is provided in advance, and
in the time difference acquisition processing, the difference is acquired by acquiring the propagation time in the air propagation based on a distance from the first position to the second position.

7. The sound processing apparatus according to claim 1, wherein
in the attenuation factor acquisition processing, the attenuation factor is acquired based on a distance from the first position to the second position.

8. The sound processing apparatus according to claim 6, wherein
the program, when executed by the processor, further causes the sound processing apparatus to execute information acquisition processing to acquire information indicating the distance from the first position to the second position.

9. The sound processing apparatus according to claim 1, wherein
the third sound signal is a sound signal in a predetermined frequency band.

10. A sound processing method comprising:
acquiring a first sound signal which is collected at a first position;
acquiring a second sound signal which is collected at a second position, transmitted from the second position by wireless communication, and received at the first position;
acquiring a difference between propagation time of a sound signal from the second position to the first position in the wireless communication of the sound signal, and propagation time of a sound from the second position to the first position in air propagation of the sound;
acquiring an attenuation factor of a sound from the second position to the first position in air propagation of the sound; and
removing a third sound signal, which was acquired by attenuating the second sound signal based on the attenuation factor and delaying the second sound signal based on the difference, from the first sound signal.

11. A non-transitory computer readable medium that stores a program, wherein the program causes a computer to execute a sound processing method comprising:
acquiring a first sound signal which is collected at a first position;
acquiring a second sound signal which is collected at a second position, transmitted from the second position by wireless communication, and received at the first position;
acquiring a difference between propagation time of a sound signal from the second position to the first position in the wireless communication of the sound signal, and propagation time of a sound from the second position to the first position in air propagation of the sound;
acquiring an attenuation factor of a sound from the second position to the first position in air propagation of the sound; and
removing a third sound signal, which was acquired by attenuating the second sound signal based on the attenuation factor and delaying the second sound signal based on the difference, from the first sound signal.
